(19) United States
(12) Patent Application Publication
(10) Pub. No.: US 2015/0024727 A1
(43) Pub. Date: Jan. 22, 2015

(54) MOBILE DEVICE REGULATION THROUGH A DIAGNOSTIC DEVICE OF A VEHICLE TO MINIMIZE VEHICULAR ACCIDENTS

(71) Applicants: Alec Michael Hale-Pletka, La Palma, CA (US); Brian Boling, Knoxville, TN (US); Scott Anderson, Austin, TX (US)

(72) Inventors: Alec Michael Hale-Pletka, La Palma, CA (US); Brian Boling, Knoxville, TN (US); Scott Anderson, Austin, TX (US)

(21) Appl. No.: 13/943,800

(22) Filed: Jul. 17, 2013

(51) Int. Cl. H04W 4/00

(52) U.S. Cl. CPC H04W 4/008
USPC 455/418; 701/70

(57) ABSTRACT

A method, system, and apparatus related to mobile device regulation through a diagnostic device of a vehicle to minimize vehicular accidents are disclosed. In one aspect, a method of mobile device regulation involves accessing a diagnostic device of the vehicle, generating a local area wireless network through the diagnostic device of the vehicle and determining that a mobile device located in an interior portion of the vehicle is a controlled mobile device. Also, the method involves controlling a functionality of at least one of the mobile device and the controlled mobile device based on a criterion stored in a database of an administration server. The method may also include establishing a communication with the mobile device located in the interior portion of the vehicle. The method involves associating a level of control that corresponds with the controlled mobile device described in the database of the administration server.

### FIELD OF TECHNOLOGY

This disclosure relates generally to the technical field of mobile device regulation, and in one example embodiment, this disclosure relates to a method and system minimizing vehicular accidents through regulating a mobile device within a vehicle.

### BACKGROUND

A driver of a vehicle (e.g. a privately owned vehicle, a public transit vehicle, a fleet transport truck) may choose to operate a mobile device (e.g. a smartphone, a laptop, a tablet, a navigation device) while driving the vehicle. For example, the driver may originate and/or accept a voice message, a text message, and/or a data transfer with the mobile device while the vehicle is in motion. The owner (e.g. a large shipping corporation, a private transportation company, parental guardian) of the vehicle may wish to control one or more of the various communicative modes of the mobile device of the driver.

In an event where the driver of the vehicle is simultaneously operating the mobile device and the vehicle, a possibility of an occurrence of a vehicular accident may be heightened. Further, in some U.S. States it may be illegal to operate a mobile device while driving a vehicle. Furthermore, the fines for breaking laws that prohibit the driver from using a mobile device may be expensive.

In an event that an accident does occur while the driver may be operating the mobile device, the driver may be held to a heightened level of responsibility than if there was no use of the mobile device. The cause of the accident may be attributed to negligence on the part of the driver. The legal repercussions thereof may be severe. This may be damaging for the reputation of the driver. The driver may suffer physical injury during the accident. The driver may lose a license to operate a motor vehicle. Further, the driver may lose a job if the accident occurred in a company owned vehicle. Accidents may be cost prohibitive for a transportation service company. Therefore, an authoritative party (e.g., a transportation company management, a parental guardian, a private individual) may wish to control the usage of a mobile device by the vehicle driver.

### SUMMARY

A method, system and apparatus related to mobile device regulation through a diagnostic device of a vehicle are disclosed. In one aspect the method includes generating a local area wireless network by a diagnostic device of a vehicle. The method also includes determining, by a back-end server communicatively coupled to a machine-readable memory and the diagnostic device of the vehicle, that a mobile device located in an interior portion of the vehicle may be a controlled mobile device. The method further includes regulating the mobile device and/or the controlled mobile device based on a criteria stored in a database of the back-end server, by the local area wireless network.

According to another aspect, a system of mobile device regulation involves a diagnostic device of a vehicle to generate a local area wireless network in an interior portion of the vehicle. Also, the system involves a client module of the mobile device to control a functionality of a mobile device based on a criteria stored in a database when located in the interior portion of the vehicle. Further, the system involves an administration server to communicatively couple an access to the database with the diagnostic device of the vehicle.

In another aspect, a mobile device regulation involves a non-transitory machine-readable medium, including instructions embodied therein that are executable through a data processing device. Instructions to communicatively couple an administrative server to a diagnostic device of a vehicle may be included. Also, the non-transitory medium may include instructions to establish a local area wireless network in the vehicle through the diagnostic device of the vehicle. Further, the non-transitory medium may include instructions to control a functionality of a mobile device, through a client module of the mobile device, when paired to the diagnostic device through in the local area wireless network, wherein a criteria stored in a database of an administration server provides an extent of the control.

The methods, system, and/or apparatuses disclosed herein may be implemented in any means for achieving various aspects, and may be executed in a form of machine readable medium embodying a set of instruction that, when executed by a machine, causes the machine to perform any of the operation disclosed herein. Other features will be apparent from the accompanying drawing and from the detailed description that follows.

### BRIEF DESCRIPTION OF DRAWINGS

Example embodiments are illustrated by way of example and not limitation in the figures of the accompanying drawing, in which like references indicate similar elements and in which:

FIG. 1A is an overview of a mobile device regulation system wherein a diagnostic device of a vehicle may be coupled with a mobile device and an administration server, according to one embodiment.

FIG. 1B is an overview of a mobile device regulation system wherein an authority may access the administration server by a user interface, according to one embodiment.

FIG. 1C depicts the diagnostic device of the vehicle, according to one embodiment.

FIG. 2 depicts a data flow between the mobile phone, the vehicle, and the administration server, according to one embodiment.

FIG. 3 is a scenario of multiple occupants of an interior portion of the vehicle and a generated message, according to one embodiment.

FIG. 4 includes a pairing data table comprising relevant data of a hypothetical mobile device regulation pairing of the vehicle, according to one embodiment.

FIG. 5 includes a user configuration table of a database comprising various configurations of mobile device regulation, according to one embodiment.

FIG. 6 comprises a hypothetical regulatory process based on the situation data of FIG. 4, according to one embodiment.

FIG. 7 is a flowchart of events of an embodiment of mobile device regulation.

FIG. 8 is a process flowchart of a pairing session between the mobile device, the diagnostic device, and/or the administration server, according to one embodiment.

Other features of the present embodiments will be apparent from the accompanying drawings and from the detailed description that follows.

### DETAILED DESCRIPTION

Example embodiments, as described below, relate to a method, a system, and a set of instructions on a machine-readable medium of mobile device regulation through a diagnostic device of a vehicle to prevent accidents, according to one or more embodiments.

According to one embodiment, a method includes generating a local area wireless network 104 by a diagnostic device 100 of a vehicle 102. The method also includes determining, by an administration server 114 communicatively coupled to a database 112 and the diagnostic device 100 of the vehicle 102, that a mobile device 106 located in an interior portion 108 of the vehicle may be a controlled mobile device 200. Further, the method also includes regulating, by the local area wireless network 104, a functionality 204 of the mobile device 106 and/or the controlled mobile device 200, based on a criteria 202 stored in a database 112 of the administration server 114.

According to another embodiment, a system of a mobile device 106 regulation includes a diagnostic device 100 of a vehicle 102 to generate a local area wireless network 104 in an interior portion 108 of the vehicle 102. The system also includes a client module of the mobile device 106 to control a functionality 204 of a mobile device 106 based on a criteria 202 stored in a database 112 when located in the interior portion 108 of the vehicle 102. Further, the system includes an administration server 114 to communicatively couple an access to the database 112 with the diagnostic device 100 of the vehicle 102.

In to another embodiment, a non-transitory machine-readable medium, includes instructions that are executable through a data processing device to communicatively couple an administration server 114 to a diagnostic device 100 of a vehicle 102. Further, instructions to establish a local area wireless network 104 in the vehicle 102 through the diagnostic device 100 of the vehicle 102 may be included. The non-transitory medium also includes instructions to regulate a functionality 204 of a mobile device 106, through a client module of the mobile device 106, when paired to the diagnostic device 100 through in the local area wireless network 104, wherein a criteria 202 stored in a database 112 of an administration server 114 provides an extent of the regulation.

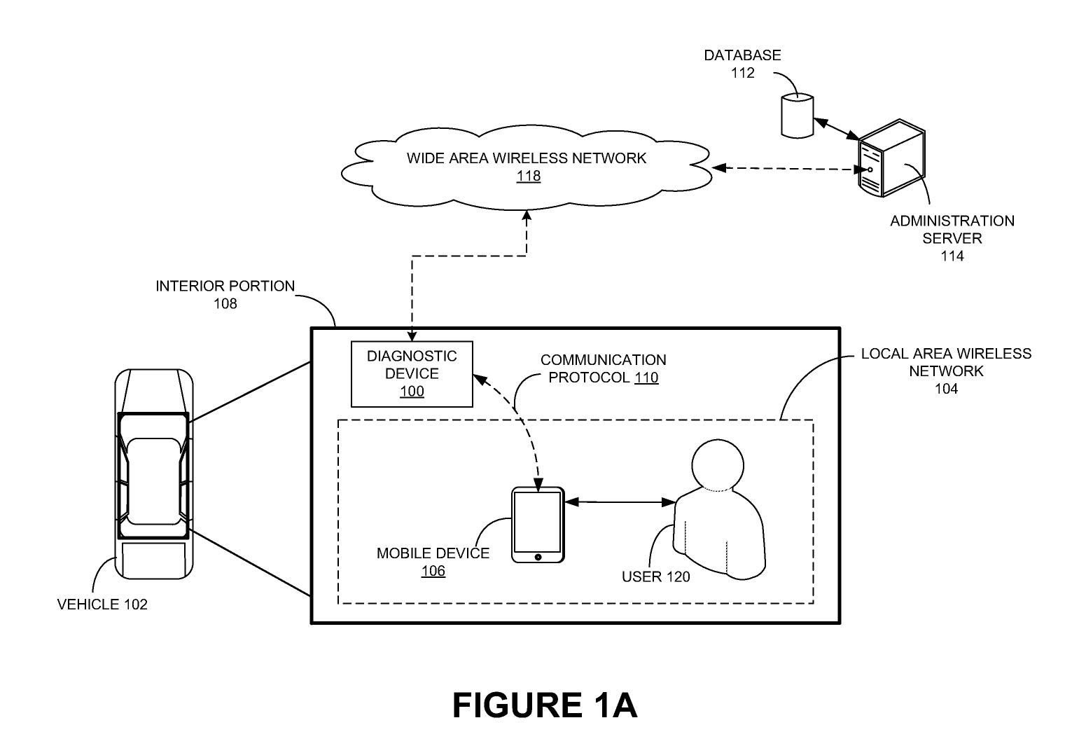

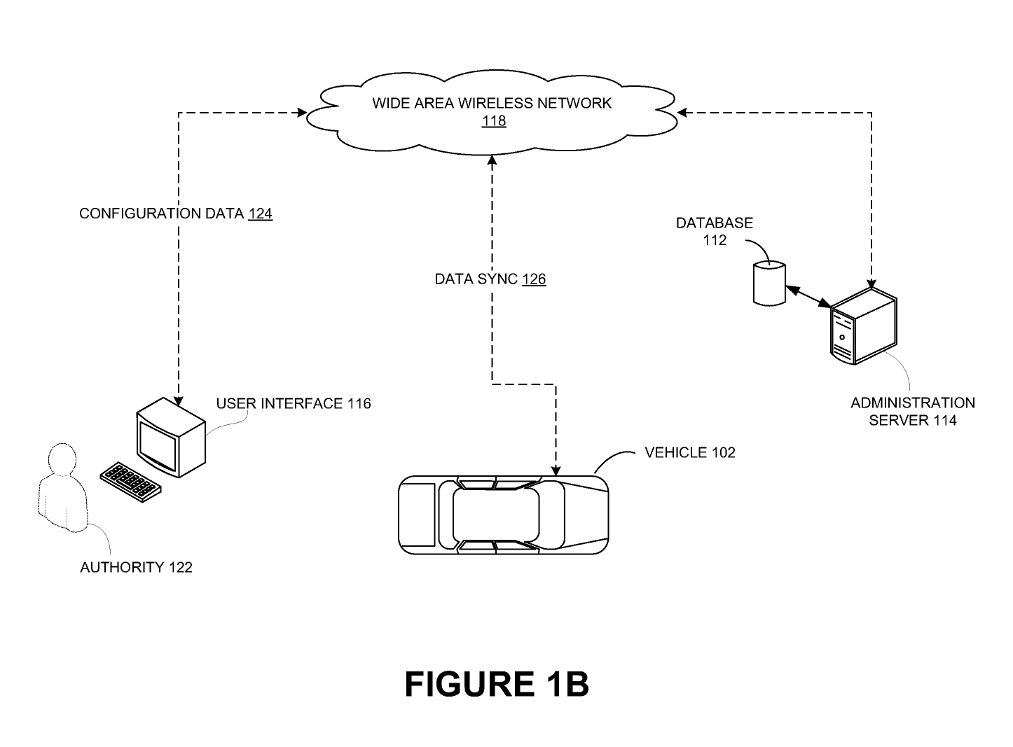

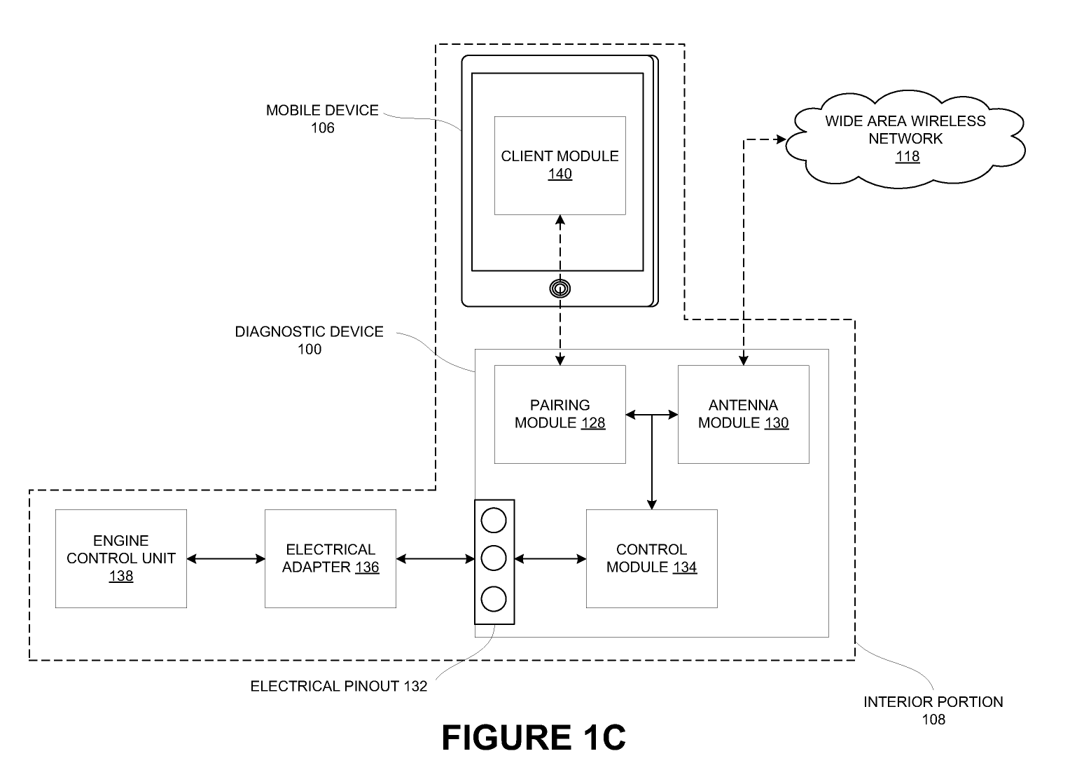

FIG. 1A is an overview of a system of mobile device regulation involving a mobile device 106 and a diagnostic device 100 of a vehicle 102. The diagnostic device 100 resides within the vehicle 102 and facilitates a communication between a vehicle engine and an auxiliary and/or external device (e.g., mobile device 106, administration server 114, digital engine diagnostic tool). The vehicle 102 may be any type of automobile (e.g., privately owned, fleet truck, company vehicle, public service vehicle, semi-truck) of a regular use on public and/or private roadways.

In one embodiment, the diagnostic device 100 may generate a local area wireless network (WLAN) 104 within the interior portion 108 of the vehicle 102. The mobile device 106 of the user 120 may enter the interior portion 108 of the vehicle 102 and may automatically connect to the WLAN 104, according to one embodiment. The diagnostic device 100 may connect to an administration server 114 via an antenna module 130 and a wide area wireless network (WAN) 118. The administration server 114 may be communicatively coupled to a database 112 (e.g., hard drive, data center, cloud-based repository) and may push mobile device regulation instructions to the mobile device 106 when a pairing session has been initiated between the mobile device 106 and the diagnostic device 100 via WLAN 104.

The WLAN 104 may be generated and/or regulated so as to communicate solely with mobile devices within the interior portion 108 of the vehicle 102. For example, a pairing module 128 of the diagnostic device 100 may generate a wireless signal over a short distance (e.g. 1-5 feet). Also, a signal strength may be configurable, according to an optional embodiment. Further, the diagnostic device 100 may include a logic (e.g., control module 134, regulation algorithm) to determine that a present device may not need pairing (e.g., devices located in surrounding vehicles at a stoplight, devices of outside persons near vehicle). The WLAN 104 may use an industry standard communication protocols 110 (e.g., Bluetooth, Wi-Fi, NFC, etc.) to connect with the mobile device 106, according to one embodiment. The mobile device 106 becomes subject to a functional mode regulation through the diagnostic device 100 upon entering the interior portion 108 of the vehicle 102.

In one embodiment of FIG. 1A, the mobile device 106 may contain a client module 140 to allow the pairing session to initiate with the diagnostic device 100. The client module 140 may be installed by an authority 122 that may wish to regulate devices (e.g., manager of a vehicle fleet, parent with teenage drivers, company owner, vehicle owner). The client module 140 may be an application, a firmware, a software, a hardware, and/or may be built into an operating system of the mobile device 106. Further, the client module 140 may have access controls to disable and/or enable various functional modes of the mobile device 106. The client module 140 may function as an automated background process and/or may not be configurable by the user 120. A data sync 126 may transfer a regulation configuration from the administration sever 114 to the mobile device 106 that the client module 140 may use to configure the mobile device 106 according to a configuration data 124 of the authority 122.

FIG. 1B depicts a communicative coupling of the vehicle 102, the administration server 114, and the authority 122, according to one embodiment. The authority 122 may use a user interface 116 to access the administration server 114. According to one embodiment, the user interface 116 may include but is not limited to a website portal, PC software, and/or a mobile device application. Further, the user interface 116 may include a terminal and a keyboard and/or a cursor device to remotely navigate and/or access the administration server 114. The authority 122 may enter the configuration data 124 through the user interface 116, according to one embodiment. The configuration data 124 may be a plurality of enforceable parameters on devices that the authority 122 exerts control over. The authority 122 may be held liable in an event of a vehicular accident wherein a mobile device usage was a contributing cause. The administration server 114 may store the configuration data 124 in the database 112, according to one embodiment. Further, the data sync 126 may transfer related configuration data 124 to the diagnostic device 100 of the vehicle 102, according to another embodiment.

FIG. 1C depicts internal elements that comprise the diagnostic device 100, according to one embodiment. The pairing module 128 may facilitate the pairing session of the diagnostic device 100 to the client module 140 of the mobile device 106, according to one embodiment. Also, an antenna module 130 may provide a connection to the administration server 114. For example, a cell tower may relay a data signal (e.g., 3G, 4G, Long Term Evolution (LTE), High-Speed Packet Access, etc.) between the administration server 114 and the antenna module 130. The antenna module 130 may receive and/or transmit on various international industry communication standards such as Global System for Mobile Communication (GSM), Wideband Code Division Multiple Access (W-CDMA), and/or International Mobile Telecommunications Service 2000 (IMTS-2000), according to one embodiment. The diagnostic device may use an industry standard communications protocol such as On-Board Diagnostics II (OBD-II) but may use legacy protocols (e.g., OBD-I, OBD-1.5) and/or other protocols (e.g., SAE, international standards, European standards, original equipment manufacturer (OEM) specific).

Further, a vehicle manufacturer may offer the diagnostic device 100 as an optional feature of a vehicle. For example, the diagnostic device may be a built-in feature, according to one embodiment. Also, the vehicle may include a console computer to initiate a pairing session between the console and the mobile device 106, wherein the console computer may be communicatively coupled to the diagnostic device 100 and/or an engine control unit 138.

According to another embodiment of FIG. 1, a database 112 contains identification information (e.g., phone number, personal identification number, international mobile subscriber identity key) of the mobile devices 106 that are subject to regulation by the administration server 114. Further, the database 112 contains a specific regulation configuration (e.g., configuration data 124) of each mobile device 106 registered therein by the authority 122. The database 112 may be communicatively coupled to the administration server 114, according to one embodiment. Also, the authority 122 may access the database 112 through the user interface 116. The authority 122 may be restricted only to view and/or edit data according to an extent of authority (e.g., authority over mobile device 106, authority over vehicle 102, authority over user 120).

In another embodiment of FIG. 1, the administration server 114 is communicatively coupled with the diagnostic device 100 of the vehicle 102 through the WAN 118. The WAN 118 enables the administration server 114 to communicate the configuration data 124 of the database 112 to the diagnostic device 100, according to one embodiment. The mobile device 106 within the interior portion 108 of vehicle 102 may be paired to the diagnostic device 100 through the pairing module 128. The client module 140 of the mobile device 106 may configure a functionality 204 of the mobile device 106 according to the configuration data 124, according to one embodiment.

In another embodiment, the vehicle 102 may be regulated by the authority 122. The authority 122 may choose to include restrictions on the vehicle 102 through the configuration data 124. The diagnostic device 100 may communicate with the engine control unit 138 through an electrical adapter 136 and thus may control an operative mode of the vehicle 102 (e.g., ignition event, RPM limit, top speed limit, transmission). Further, the diagnostic device 100 may include an electrical pinout 132 to connect with the electrical adapter 136 and/or to interface with a plurality of auxiliary devices (e.g., digital engine diagnostics tool, troubleshooting tool, programming tool, override tool). Furthermore, the authority 122 may essentially have access to regulate a plurality of vehicle 102 functions (e.g., engine timing, ignition, RPM, speed, transmission, cabin functions, A/C, airbags, etc.) and/or critical systems by way of the diagnostic device 100 being in communication with the engine control unit 138. The engine control unit 138 may be a central computer that may regulate all functions of all systems (e.g., drivetrain, powertrain, electrical systems, cabin systems, etc.).

Further, a user 120 may occupy the interior portion 108 of the vehicle 102 and may associate with the mobile device 106. The user 120 may be a driver or a passenger of the vehicle and the extent of the control applied to the mobile device 106 may depend on the administration server 114 being able to determine a distinction between whether a given user 120 may be the driver or a passenger. For example, the driver may be subject to stricter controls than the passenger may be.

Important of FIG. 1, is the path of communication from the database 112 to the mobile device 106 of the user 120 and to vehicle 102. The diagnostic device 100 may be an auxiliary device of the vehicle that may generate the WLAN 104 and simultaneously connect to the WAN 118, according to one embodiment. Furthermore, the system of FIG. 1 provides the authority 122 with a capability to control the mobile device 106 of the user 120 when the mobile device 106 becomes located in the interior portion 108 of the vehicle 102. Additionally, the administration server 114 may simultaneously communicate with multiple diagnostic devices of multiple unrelated vehicles and thus may control multiple mobile devices, according to one embodiment.

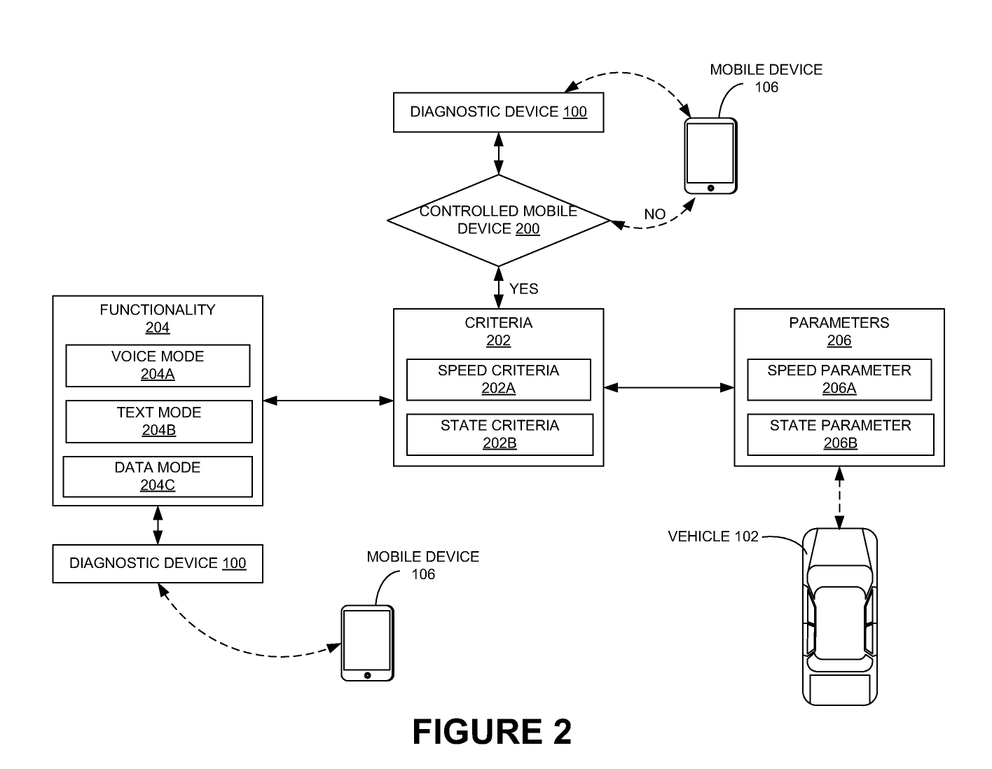

FIG. 2 depicts a process flow of a regulation process from the perspective of the mobile device 106 upon entering the local area wireless network 104 of the diagnostic device 100. First, the mobile device 106 connects to the diagnostic device 100 which may be paired to the administration server 114 through the WAN 118. Or, the diagnostic device 100 may initiate a pairing to the administration server 114 after an initial pairing session may be established with the mobile device 106, according to one embodiment. Once the mobile device 106 may be paired to the administration server 114 by the diagnostic device 100, the administration server 114 may determine whether the mobile device 106 pertains to a controlled mobile device 200 of the database 112, through a data sync 126, according to one embodiment (e.g., a device registered in the database 112 by the authority 122). If the mobile device 106 determines not to be a controlled mobile device 200 of database 112, then functionality 204 of the mobile device 106 may not be interrupted, according to one embodiment.

In one possible embodiment, the authority 122 may decide to implement regulations regardless of whether or not the mobile device 106 determines to be a controlled mobile device 200. Additionally, the user interface 116 may also choose to implement regulations of the vehicle 102 regardless of whether or not the mobile device 106 determines to be the controlled mobile device 200.

It may be noted that a plurality of functional modes of the vehicle 102 and the mobile device 106 may be subject to regulation through the administration server 114 and diagnostic device 100. Since the diagnostic device 100 may be communicatively coupled to the engine control unit 138, engine functions may be subject to regulation (e.g., ignition event, RPM, etc.). The authority 122 may choose a level of risk mitigation to achieve with the system of mobile device regulations.

According to one embodiment, the administration server 114 determines that the mobile device 106 pertains to a controlled mobile device 200. The regulation process proceeds to check a set of criteria 202 of the vehicle 102, according to one embodiment. A present state of the vehicle 102 may be determined based on the criteria 202 in order to base the level of functionality 204 controls on. In one embodiment, a speed criterion 202A may be determined by the user interface 116 and may be used to qualify a speed of the vehicle 102 in order to determine whether certain functionality 204 and/or certain vehicle controls may be applied. For example, if the driver of vehicle 102 stops the vehicle 102 on the side of the road in order to use the mobile device 106, the speed criterion 202A may be set to allow full functionality 204 of the mobile device 106 when the vehicle 102 becomes stationary and/or while the engine is idling (e.g., truck drivers often leave engine on in idle for long periods of time). In another example, the speed criteria 202A may be set to allow a certain functionality 204 until the vehicle 102 surpasses a rate of “20 miles per hour”. The criteria 202 may vary according to a desired level of risk mitigation that the authority 122 may be trying to achieve.

In one embodiment, an operational state criteria 202B may be determined by the authority 122 and used to determine whether an operational state of the vehicle qualifies for certain vehicle 102 controls or certain mobile device 106 controls. For example, the authority 122 may select to have all functionality 204 disabled whenever the engine of vehicle 102 exists in a running state. According to another embodiment, the authority 122 may select to have all functionality 204 disabled except Bluetooth pairing, emergency voice calls, and GPS application data whenever the engine of the vehicle 102 exists in a running state. In may be recalled that the authority 122 may determine a plurality of regulation configurations pertaining to the vehicle 102 and/or the mobile device 106, according to a desired level of risk mitigation.

According to another embodiment, the functionality 204 of mobile device 106 may be configured by the authority 122. The functionality 204 may comprise various communicative modes such as, a voice mode 204A, a text mode 204B, and/or a data mode 204C. Any one and/or combination of the functionality 204 may be enabled and/or disabled based on the criteria 202 at discretion of the authority 122.

Additionally, the authority 122 may use the criteria 202 to determine whether or not to control the vehicle 102 according to a parameter 206. Wherein, the parameter 206 may include a speed parameter 206A and/or a state parameter 206B. The parameter 206 may be set by the authority 122 to enforce a level of control on the vehicle 102. For example, the authority 122 may select to restrict the speed of vehicle 102 according to the speed parameter 206A based on the speed criteria 202A based on the present state of the mobile device 106. In another example, the authority 122 may choose to have the diagnostic device 100 actively prohibit an ignition of the engine of the vehicle 102 until the mobile device 106 may be disabled.

FIG. 2 demonstrates how the process of mobile device regulation acts upon the mobile device 106 and/or the vehicle 102 by limiting specific functional modes 204 of the operation of the mobile device 106 and/or by enforcing parameters 206. When the mobile device 106 establishes a connection with the diagnostic device 100, the mobile device 106 and the vehicle 102 each may become subject to the administration server 114 and further subject to the user interface 116. The administration server 114 includes the criteria 202 to determine which functionality 204 and/or which parameter 206 may be needed in order to regulate the mobile device 106 so as to minimize vehicular accidents.

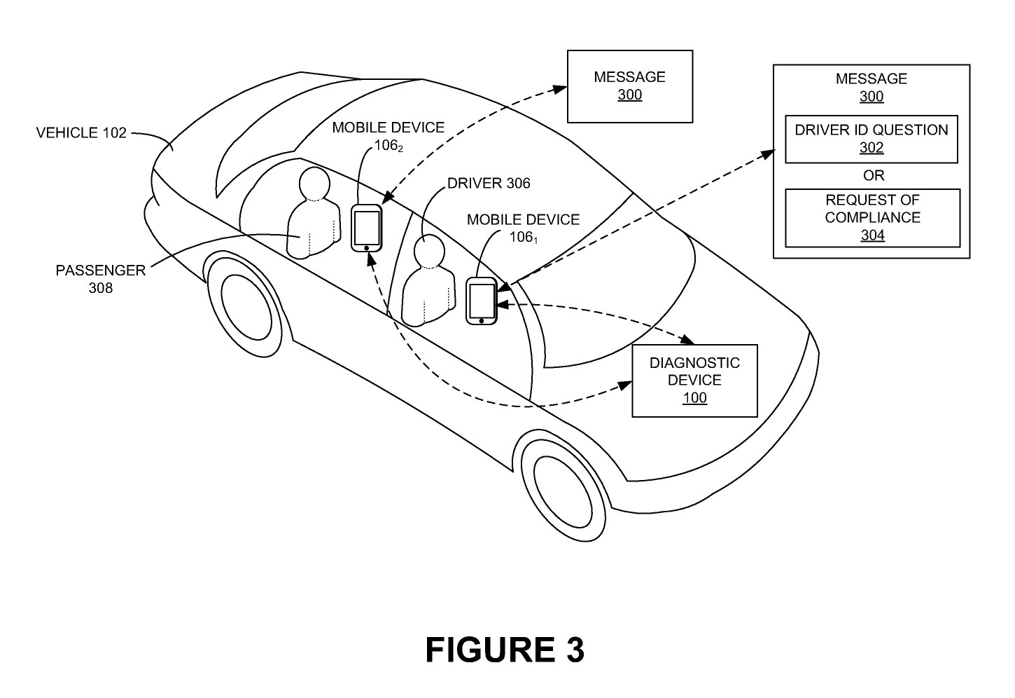

FIG. 3 is a view of the interior portion 108 of the vehicle 102 with two users 120 of mobile devices 106, according to one embodiment. The users 120 of FIG. 3 are one of a driver 306 and a passenger 308. Further, the driver 306 may be the user 120 of the mobile device 106₁ and the passenger 308 may be the user 120 of the mobile device 106₂. Furthermore, the embodiment of FIG. 3 may occur at a time prior to the ignition of the engine of the vehicle 102.

In another embodiment of FIG. 3, the mobile device 106₁ and the mobile device 106₂ are communicatively coupled with the diagnostic device 100 of the vehicle 102 through the WLAN 104 of the pairing module 128. Message 300 may be generated to mobile device 106₁ and to mobile device 106₂ from the administration server 114 of FIG. 1A and/or the control module 134 of FIG. 1C. Further, the message 300 may contain either a driver identification question 302 or a request of compliance 304, according to the number of occupants in the interior portion 108 of the vehicle 102.

In an embodiment such as the one of FIG. 3, wherein multiple occupants may occur in the interior portion 108 of the vehicle 102, the mobile device regulation system relies on the users 120 to provide the identity of the driver 306. The administration server 114 may disable the functionality 204 of the mobile device 106₁ of the driver 306. The administration server 114 may allow the mobile device 106₂ of the passenger 308 to retain functionality 204. For example, the driver identification question 302 that comprises the message 300 may be delivered to each mobile device 106 of each user 120, wherein the passenger 308 would choose not to identify as the driver 306. Thus, the administration server 114 may not disable the functional modes 204 of the mobile device 106₂ that may identify as the device belonging to the passenger 308.

In another embodiment, implicit in a previously disclosed embodiment, the diagnostic device 100 may not allow the vehicle 102 to proceed with engine ignition. For example, each user 120 may choose not to identify as the driver 306 of the vehicle 102. The actual driver may attempt to mislead the administration server 114 about an intention to operate the vehicle 102 as the driver 306 and/or may refuse to respond to the message 300. Consequently, the vehicle 102 may be prohibited from proceeding with a further state of operation by the administration server 114 through the diagnostic device 100, until the truthful driver 306 complies with the driver id question 302 of message 300. Or, the authority 122 may instead choose to allow all functionality 204 and all vehicle capabilities to remain enabled, wherein the administration server 114 delivers a report to the authority 122 to inform of a violation by the driver 306 (i.e., parents may determine whether a teenage driver may be lying about mobile device usage while driving). The extent of operational functions of the vehicle 102 and the mobile device 106 are subject to the risk mitigation of the authority 122. Further, the system reaction to a violation by the user 120 (e.g., lying, breaking set rules of mobile device usage while driving) may be configurable by the authority. A wide range of configurations (e.g., configuration data 124) may be possible.

Also, in an embodiment where only one occupant enters the vehicle 102, the diagnostic device 100 may assume that the occupant intends to drive the vehicle 102. For example, the message 300 may contain a request of compliance 304 on the part of the driver 306. Or, the message 300 may inform of an automated disabling of the functionality 204 of the mobile device 106. The operation of the vehicle 102 by the user 120, as the driver 306, may be prohibited until the user 120 agrees to comply with the diagnostic device 100 in the regulation of the functionality 204 of the mobile device 106 of the user 120, through the message 300, according to one embodiment. Or, the operation of the vehicle 102 may be uninterrupted due to the automated disabling of the functionality 204 of the mobile device 106, according to one embodiment.

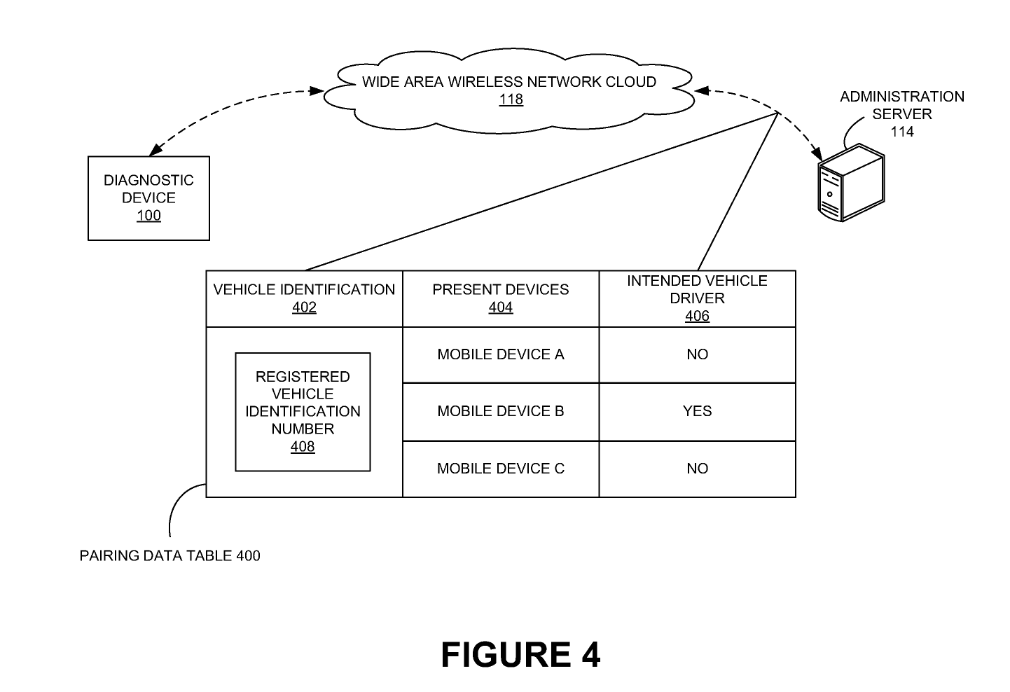

FIG. 4 is a view of a data table comprising pairing data retrieved from an embodiment of mobile device regulation through the administration server 114 and the diagnostic device 100. Presently, pairing data table 400 comprises information that may be needed and/or helpful to the administration server 114 in a determination of which regulation configuration to may apply to a given mobile device 106, user 120, and/or vehicle 102.

Pairing data table 400 comprises a column of present devices 404. The present devices 404 may include any of the devices within the interior portion 108 of the vehicle 102 that may be detected by the diagnostic device 100. In the example of FIG. 4, the list of present devices 404 includes exemplary devices (e.g., mobile device A, mobile device B, mobile device C).

According one embodiment, the pairing data table 400 reveals a registered vehicle identification number 408 of a vehicle that may be communicatively coupled to the administration server 114 through the diagnostic device 100. The registered vehicle identification number 408 may be a plurality of different identification means (e.g., vehicle identification number (VIN), SIM card of a diagnostic device, license plate, original identification number generated by administration server 114, customer number). The administration server 114 may use the identification number 408 in a determination of which regulations apply to a given vehicle of the database 112 and identified in the pairing data table 400.

Additionally, the pairing data table 400 of FIG. 4 may notify the administration server 114 about which of the present devices 404 may be the device 106 of the intended vehicle driver 406. The intended vehicle driver 406 may be determined by the response of the user 120 of each mobile device 106 through the message 300 of the diagnostic device 100. In the example of FIG. 4, the mobile device B identifies as the mobile device 106 belonging to the driver 306.

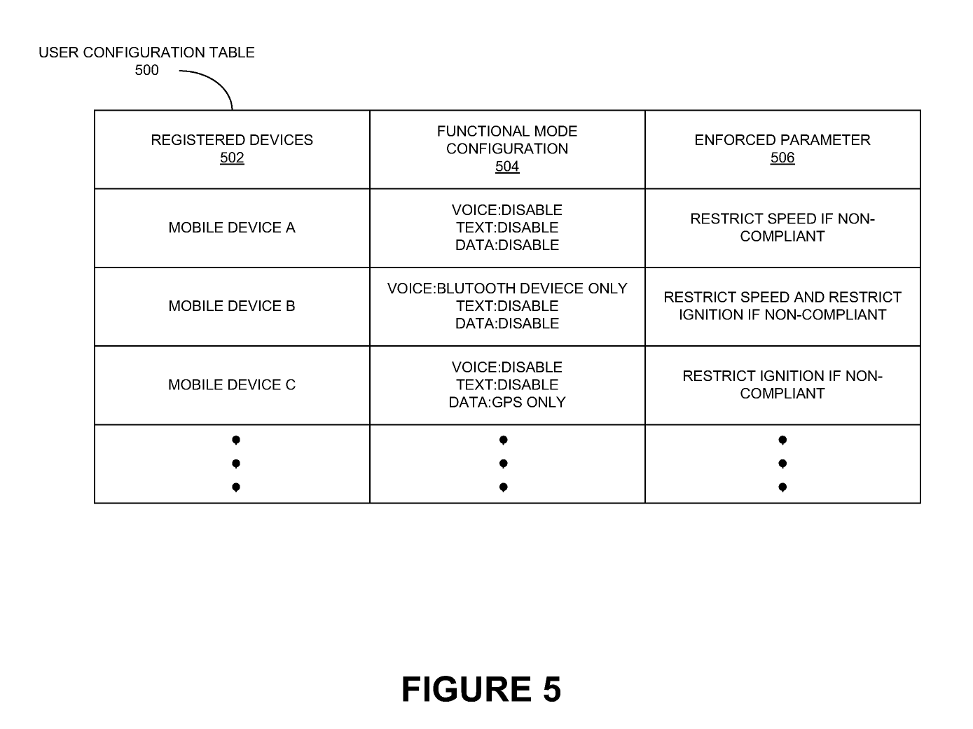

In FIG. 5, a user configuration table 500 displays various configurations of regulation of a mobile device 106. The column of registered devices 502 displays a hypothetical list of all of the mobile devices 106 that may be registered as a controlled device 200 of the administration server 114. Mobile devices A, B, and C are included in an exemplary embodiment of the user configuration table 500 but the user configuration table 500 may extend to include any number of devices 106. Further, the authority 122 may determine how to regulate mobile devices that may not be registered but may be potential drivers (e.g., teenager's friends drive vehicle), according to the desired level of risk mitigation.

The functional mode configuration column 504 includes individual combinations of restrictions corresponding to each registered device 502. The functional mode configuration 504 may embody the functionality 204 of FIG. 2. For example, mobile device B may be restricted to only the voice mode 204A of functionality 204 only when paired with a Bluetooth earpiece. Other restrictions and/or combinations thereof may be possible (e.g., GPS data/application, Bluetooth pairing, headphone jack, background data functionality may be required by applications, alerts through data, text data may be paired to a vehicle console). In another example, all functionality 204 may be restricted in the functional mode configuration 504 (e.g., see mobile device A in FIG. 5).

The user configuration table 500 further comprises an enforced parameter 506. Each registered device 502 may possess a specific enforced parameter 506. For example, the diagnostic device 100 of the vehicle 102 of mobile device A may be set to only restrict the speed of the vehicle in an event where the mobile device 106 may refuse to comply with the restrictions. The user 120 of mobile device A may choose to retain functionality 204 at the cost of the enforced parameter 506. In another example of the enforced parameters 506, mobile device C may have restriction placed on an ignition event of the vehicle that the user 120 may be attempting to drive. Enforced parameters 506 and functional mode configuration 504 may be set by the authority 122, according to the desired level of risk mitigation

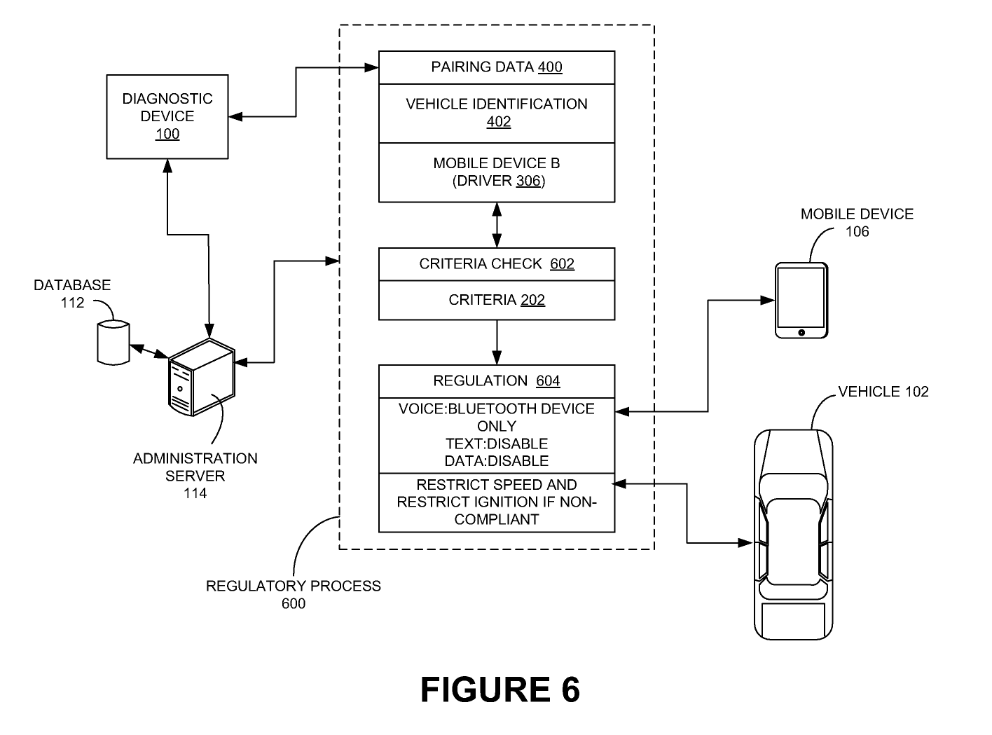

FIG. 6 is a data flow schematic of a system of mobile device regulation involving the diagnostic device 100, the vehicle 102, the mobile device 106, and the administration server 114. Most notably, FIG. 6 displays a regulatory process 600 which demonstrates how each component of device regulation may relate to different stages of the regulatory process 600. Each of the diagnostic device 100, the vehicle 102, the mobile device 106, and the administration server 114 interface with a certain stage of the regulatory process 600.

Primarily, the diagnostic device 100 sends a report of the paired mobile devices of the interior portion 108 of the vehicle 102 to the administration server 114. The report may be in the form of the pairing data table 400 of FIG. 4, according to one embodiment. In a continuation of the exemplary embodiment of FIG. 4, the “mobile device B” belongs to the driver 306 of the vehicle 102 and may be viewed in the embodiment of the pairing data table 400 of FIG. 6. Further, the registered vehicle identification number 408 may also be supplied into an initial stage of the regulatory process 600 through the diagnostic device 100.

The regulatory process 600 uses the pairing data table 400 to check the various criteria 202 through a criteria check 602. For example, each registered vehicle may be associated with a criteria configuration to base the necessity of mobile device regulation on. In one such embodiment, the state criteria 204B may be checked for the registered vehicle of FIG. 6. Therefore, before the administration server 114 enforces functionality restrictions, the diagnostic device 100 may check the state of the vehicle to ensure that the engine state may be off. The criteria check 602 may also be requested periodically by the administration server 114 to verify the current criteria 202 of the vehicle 102 that may require regulations to be enforced.

In another exemplary embodiment of the criteria check 602 of the regulatory process 600, the speed criteria may be used. For example, the administration server 114 may request the diagnostic device 100 to check the current speed of the vehicle 102. The administration server 114 may then determine if the current speed of the vehicle 102 constitutes mobile device regulations according to the level of regulation set by an user interface 116, according to one embodiment. The control module 134 of FIG. 1C may regulate a period criteria check 602, according to the configuration data 124 of the authority 122.

According to another embodiment of the regulatory process 600, device regulations 604 may be enforced on either the vehicle 102 or the mobile device 106 of the user 120, wherein mobile device 106 may be mobile device B of the pairing data table. From regulation 604 of FIG. 6, an exemplary regulatory configuration may be observed. The voice mode 204A of the mobile device 106 may be restricted to allow functionality only when paired with a Bluetooth device (e.g, headset, vehicle hands-free console), according to one embodiment. Further, the text mode 204B and data mode 204C of the mobile device 106 may be disabled, according to FIG. 6. Furthermore, a speed restriction may be placed on the vehicle and/or an ignition restriction based on the criteria check 602.

In a further embodiment of the present system of mobile device regulation, the diagnostic device 100 may server as an intermediary between the administration server 114 and the mobile device 106 and/or the vehicle 102. The diagnostic device 100 may generate the message 300 to the mobile device 106. The diagnostic device 100 may also pairing data table 400, gathered from the interior portion 108 of the vehicle 102, to the administration server 114 for processing. Further, the diagnostic device 100 may enforce the determined regulations 604 of the regulatory process 600 by disabling the mobile device 106 of the driver 306 through the application of the mobile device 106.

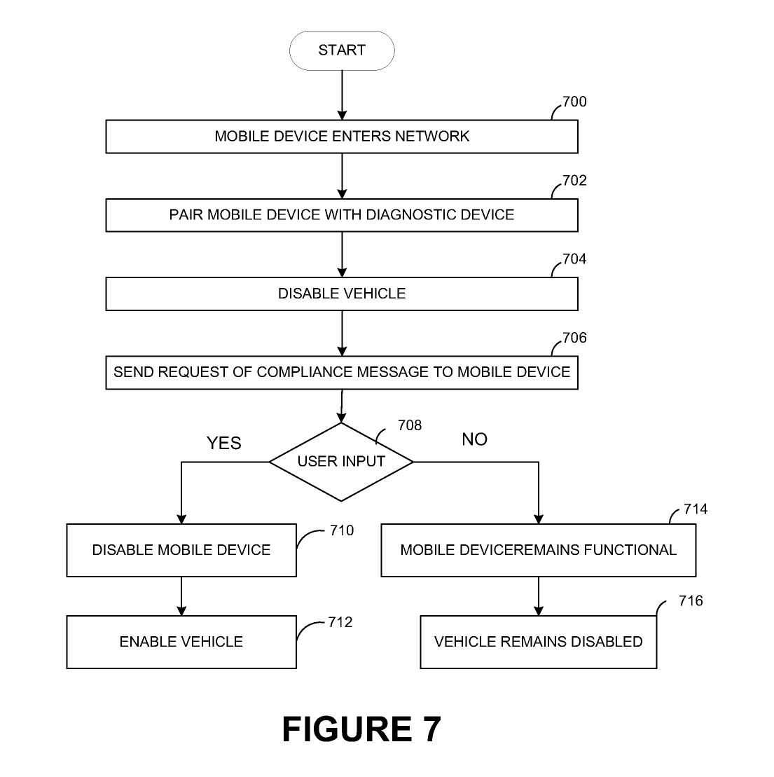

FIG. 7 is a process flow diagram of another embodiment of a mobile device regulatory process 600. In operation 700, the mobile device 106 may enter the local area wireless network 104 of the interior portion 108 of the vehicle 102. In operation 702, the administration server 114 checks to determine that the mobile device 106 may be one of the registered devices 502. In operation 704, the vehicle may be temporarily disabled until the conclusion of the regulatory process 600 with a compliant and/or incompliant user.

In operation 706, the diagnostic device 100 transmits the request of compliance 304 from the administration server 114 to the mobile device 106. In the previously disclosed event where more than one mobile device 106 may be present, operation 706 may include sending the driver identification question 302. In operation 708, the user 120 may agree to comply with the diagnostic device 100 in the regulation of the mobile device 106. Or, in operation 708, the user 120 may not agree with the regulations of the diagnostic device 100. In an event of user incompliance, operation 714 may proceed wherein the mobile device 106 may retain all functional modes. In operation 716, the vehicle 102 may remain in the disabled state of operation 704.

In an event of user compliance in operation 708, wherein the user 120 generates the compliance, operation 710 may proceed to disable the mobile device 106. In operation 712, the vehicle may become enabled as the disabling of operation 704 may be thereby rescinded, according to embodiment.

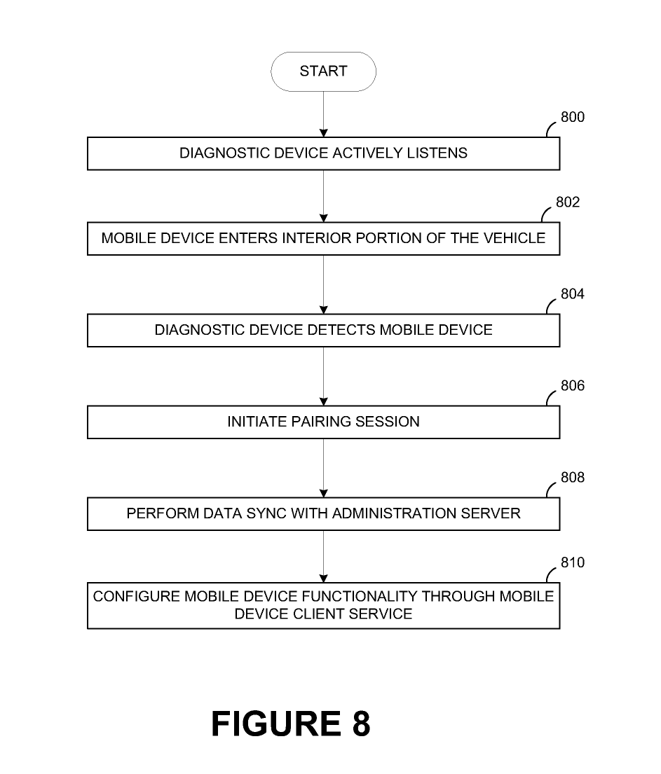

FIG. 8 is a process flowchart of a pairing session between the mobile device, the diagnostic device, and/or the administration server, according to one embodiment. In operation 800, the diagnostic device 100 may be actively listening and/or searching through the pairing module 128 to determine a mobile device 106 with which to initiate a pairing session with. In operation 802, a mobile device 106 may enter the interior portion 108 of the vehicle 102. In operation 804, the diagnostic device 100 may detect the mobile device 106 in the interior portion 108 of the vehicle 102. In operation 806, the pairing module 128 may initiate a pairing session with the mobile device 106. In operation 808, the control module 134 may perform a data sync 126 with the administration server 114 via the antenna module 130. In operation 810, the functionality 204 of the mobile device 106 may be configured by the client module 140 based on the data sync 126 and communicative coupling through the pairing session.

An example will now be described in which the various embodiments will be explained in a hypothetical scenario. A hypothetical mobile device regulation service, “XYZ Regulators”, may be enlisted by a hypothetical fleet truck company “ABC Trucking”. ABC Trucking wishes to ensure a high level of safety on the roadways by requiring that all drivers of the company fleet trucks are not using a mobile device (e.g., smart phone, tablet, cellular phone, laptop).

In many of the United States, driving a vehicle and operating mobile devices simultaneously may be illegal. ABC Trucking may implement company rules to prohibit company drivers from using devices but may find it difficult to enforce the rules on the individual drivers (e.g., drivers are frequently out of out of the view of company management, mobile device usage can be easily hidden). As a result, ABC Trucking may feel that the possibility of company drivers using mobile devices may largely increase the risk of an accident, the degree of company liability, and the possibility of legal fines. XYZ Regulators may therefore be contracted by ABC Trucking.

XYZ Device Regulation may require that all diagnostic devices of the company vehicles be retrofitted through a variety of possibilities (e.g., software module installation, hardware add-on to provide wireless capability). Additionally, XYZ Regulators may request ABC Trucking to provide a desired level of regulation to be enforced on the vehicles and/or the mobile devices of the drivers. As an option, XYZ Regulators may allow ABC Trucking to set different levels of regulation for different mobile devices. For example, company managers may have higher privileges, newly hired drivers may have stricter regulations, problem drivers may be uniquely targeted, data and/or GPS restrictions may vary, device type may vary. All of the specifications provided by ABC Trucking may be stored in a database of an administration server of XYZ Regulators.

When the driver of a vehicle owned by ABC Trucking enters the interior portion of the vehicle, the diagnostic device of the vehicle may generate a message to the mobile phone of the driver. The message may be a request of a compliance with a regulation to be imposed and/or an inquiry of an intent to operate the vehicle as the driver. In one embodiment, the driver may then agree to comply with the diagnostic device and may offer a functionality of the mobile device in return for a permission to operate the vehicle as the driver.

In another embodiment, the driver may not comply and/or may specify that there may not be an intent to drive the vehicle (e.g., resting and/or recreating in the cabin, waiting in line at a weigh station, waiting at a shipping yard). The system of XYZ Regulators effectively enforces the mobile device usage rules of ABC Trucking. Further, the system of XYZ Regulators allows the drivers of the vehicles to use mobile devices at appropriate times when safety may not be a concern.

Although the present embodiments have been described with reference to a specific example embodiment, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative in rather than a restrictive sense.

What is claimed is:

1. A method comprising:
generating, by a diagnostic device of a vehicle, a local area wireless network;
determining, by an administration server communicatively coupled to a machine-readable memory and the diagnostic device of the vehicle, that a mobile device located in an interior portion of the vehicle may be a controlled mobile device; and
regulating, by the local area wireless network, a functionality of at least one of the mobile device and the controlled mobile device based on a criteria stored in a database of the administration server.

2. The method of claim 1, further comprising:
establishing, by the local area wireless network, a communication with the mobile device located in the interior portion of the vehicle;
restricting, by the on-board vehicle computer, the local area wireless network such that the local area wireless network may be communicable solely in the interior portion of the vehicle;
initiating, by a pairing service, a pairing session between a client module of the mobile device and the diagnostic device.

3. The method of claim 1, wherein a determination that the mobile device may be the controlled mobile device may be made through the administration server communicatively coupled with the diagnostic device through at least one of a wide area wireless network and a cellular antenna.

4. The method of claim 2, further comprising:
associating, by the client module, a level of control that corresponds with the controlled mobile device described in the database of the administration server; and
providing, by a user interface, an ability of an authoritative party to configure the level of control of at least one of the controlled mobile device and a controlled vehicle of a database of the administration server.

5. The method of claim 1 wherein the functionality is at least one of:
a text message mode of the mobile device that provides an interface to enable a Short Message System (SMS) communication between a user and at least one other user,
a voice communication mode of the mobile device to permit the user and the at least one other user to communicate through a speech that may be commonly understandable between the user and the at least one other user, and
a data mode of the mobile device.

6. The method of claim 1 wherein the criteria may comprise at least one of:
a speed of the vehicle while in a transit between at least one location and a plurality of locations with the mobile device in the interior portion of the vehicle, and
an operational state of the vehicle wherein at least one of a critical system of the vehicle and a plurality of critical systems of the vehicle may be operating while the mobile device may be in the interior portion of the vehicle.

7. The method of claim 4 further comprising:
limiting a maximum speed of the vehicle when the mobile device may be operational in the vehicle based on a speed parameter associated with the vehicle; and
disabling an operational state of the vehicle when the mobile device may be operational based on an operational state parameter associated with the vehicle,
wherein the speed parameter and the operational state parameter are stored in the database of the administration server.

8. The method of claim 2 further comprising:
identifying, upon determining an occurrence of the mobile device in the interior portion of the vehicle, whether a user of the mobile device may be an intended driver of the vehicle, through an alert message, wherein the alert message may be at least one of a driver identification question and a request of compliance.

9. A mobile device regulation system comprising:
a diagnostic device of a vehicle to generate a local area wireless network in an interior portion of the vehicle;
a client module of the mobile device to regulate a functionality of a mobile device based on a criteria stored in a database when located in the interior portion of the vehicle; and
an administration server to communicatively couple an access to the database with the diagnostic device of the vehicle.

10. The system of claim 9 wherein the diagnostic device:
to establish a communication with the mobile device located in the interior portion of the vehicle through the local area wireless network,
to restrict the local area wireless network such that the local area wireless network may be communicable solely in the interior portion of the vehicle, and
to determine that the mobile device may be a controlled mobile device of the administration server.

11. The system of claim 9 wherein the diagnostic device:
to associate a level of control that may be described in the database of the administration server with the controlled mobile device through the client module of the mobile device.

12. The system of claim 11 wherein the functionality is at least one of:
a text message mode of the mobile device,
a voice communication mode of the mobile device, and
a data mode of the mobile device.

13. The system of claim 11 wherein the criteria is at least one of:
a speed of the vehicle while in a transit between at least one location and a plurality of locations with the mobile device in the interior portion of the vehicle, and
an operational state of the vehicle wherein at least one of a critical system of the vehicle and a plurality of critical systems of the vehicle may be operating while the mobile device may be in the interior portion of the vehicle.

14. The system of claim 11 wherein the diagnostic device:
to limit a maximum speed of the vehicle when the mobile device may be operational in the vehicle based on a speed parameter associated with the vehicle; and
to disable an operational state of the vehicle when the mobile device may be operational based on an operational state parameter associated with the vehicle,
wherein the speed parameter and the operational state parameter are stored in the database of the administration server.

15. The system of claim 12 wherein the local area wireless network:
to identify, upon determining an occurrence of the mobile device in the interior portion of the vehicle, whether a user of the mobile device may be an intended driver of the vehicle, through an alert message, wherein the alert message may be at least one of a driver identification question and a request of compliance.

16. The system of claim 12 wherein the administration server:
to provide, by a user interface, an ability of an authoritative party to configure the level of control of the mobile device and the vehicle of the database of the administration server.

17. A non-transitory machine-readable medium, including instructions embodied therein that are executable through a data processing device, comprising:
instructions to communicatively couple an administrative server to a diagnostic device of a vehicle;
instructions to establish a local area wireless network in the vehicle through the diagnostic device of the vehicle; and
instructions to regulate a functionality of a mobile device, through a client module of the mobile device, when paired to the diagnostic device through in the local area wireless network, wherein a criteria stored in a database of an administration server provides an extent of the regulation.

18. The non-transitory medium of claim 17, further comprising:
instructions to establish a communication, through the client module, between the mobile device and the local area wireless network of the vehicle;
instructions to determine that the mobile device may be a controlled mobile device;
instructions to generate an alert message to determine whether a user of the mobile device is an intended driver of the vehicle, wherein the alert message is at least one of a driver identification question and a request of compliance, upon determination that the mobile device may be located in an interior portion of the vehicle; and
instructions to associate a level of control that corresponds with the controlled mobile device described in the database.

19. The non-transitory medium of claim 18, further comprising:
instructions to provide a user interface of the administration server that allows a configuration of the level of control by an authoritative party;
instructions to provide, through the user interface, an ability for the authoritative party to control the functionality of the mobile device, wherein the functionality may be at least one of a text message mode of the mobile device, a voice communication mode of the mobile device, and a data mode of the mobile device;
instructions to provide, through the user interface, an ability for the authoritative party to select the criteria wherein the criteria may be at least one of a speed of the vehicle while in a transit and an operational state of the vehicle; and
instructions to allow the authoritative party to set a parameter for each of the criteria of the vehicle.

20. The non-transitory medium of claim 17, further comprising:
instructions to control the functionality of the mobile device and to facilitate the communication between the mobile device and the local area wireless network of the vehicle through the client module;
instructions to limit the speed of the vehicle while in transit based on the parameter set by the authoritative party; and
instructions to disable an operational state of the vehicle based on the parameter set by the authoritative party.
